(19) United States
(12) Patent Application Publication
(10) Pub. No.: US 2021/0064585 A1
(43) Pub. Date: Mar. 4, 2021

(54) METHODS AND DEVICES FOR PROVIDING TRAVERSABLE KEY-VALUE DATA STORAGE ON BLOCKCHAIN

(71) Applicant: Advanced New Technologies Co., Ltd., George Town (KY)

(72) Inventor: Shenglong CHEN, Hanghzhou (CN)

(73) Assignee: Alibaba Group Holding Limited

(21) Appl. No.: 16/773,405

(22) Filed: Jan. 27, 2020

Related U.S. Application Data
(63) Continuation of application No. PCT/CN2019/103809, filed on Aug. 30, 2019.

(51) Int. Cl. G06F 16/182; H04L 9/06; G06F 21/60

(52) U.S. Cl. CPC G06F 16/1837; G06F 21/604; H04L 9/0637

(57) ABSTRACT

Disclosed herein are methods, devices, and apparatuses, including computer programs stored on computer-readable media, for providing traversable key-value data storage. One of the methods includes: receiving a first user-provided key-value pair for recordation on a storage system, the first user-provided key-value pair comprising a first user-provided key and a first user-provided value; assigning a first index to the first user-provided key-value pair; generating a first index-to-key key-value pair, the first index-to-key key-value pair having a key comprising the first index and a value comprising the first user-provided key; generating a first key-to-index key-value pair, the first key-to-index key-value pair having a key comprising the first user-provided key and a value comprising the first index; and storing the first user-provided key-value pair, the first index-to-key key-value pair, and the first key-to-index key-value pair on the storage system.

### TECHNICAL FIELD

The specification relates generally to computer technologies, and more particularly, to methods and devices for providing traversable key-value data storage on a blockchain.

### BACKGROUND

Blockchain systems, also known as distributed ledger systems (DLSs) or consensus systems, may enable participating entities to store data securely and immutably. Blockchain systems may include any DLSs, without referencing any particular use case, and may be used for public, private, and consortium blockchain networks. A public blockchain network is open for all entities to use the system and participate in the consensus process. A private blockchain network is provided for a particular entity, which centrally controls read and write permissions. A consortium blockchain network is provided for a select group of entities, which control the consensus process, and includes an access control layer.

A blockchain system is implemented using a peer-to-peer (P2P) network, in which the nodes communicate directly with each other, e.g., without the need of a fixed, central server. Each node in the P2P network may initiate communication with another node in the P2P network.

A blockchain system maintains one or more blockchains. A blockchain is a data structure for storing data, such as transactions, that may prevent tampering and manipulation of the data by malicious parties. The blockchain system may store data as key-value pairs. Each key-value pair may include a key and a value that can be retrieved using the key. For example, a user's financial account information may be stored as a key-value pair on the blockchain system. The key-value pair may include an account number as the key and a balance as the value. In this manner, the account number can be used as the key to retrieve the value indicating the balance of the user's financial account. However, if the user has multiple key-value pairs stored on the blockchain system, e.g., if the user has multiple financial accounts, it may become difficult for the blockchain system to traverse through all these key-value pairs. Therefore, there is a need for a method to improve the ability to traverse through key-value pairs stored on blockchain systems.

### SUMMARY

In one aspect, a computer-implemented method for providing traversable key-value data storage includes: receiving a first user-provided key-value pair for recordation on a storage system, the first user-provided key-value pair comprising a first user-provided key and a first user-provided value; assigning a first index to the first user-provided key-value pair; generating a first index-to-key key-value pair, the first index-to-key key-value pair having a key comprising the first index and a value comprising the first user-provided key; generating a first key-to-index key-value pair, the first key-to-index key-value pair having a key comprising the first user-provided key and a value comprising the first index; and storing the first user-provided key-value pair, the first index-to-key key-value pair, and the first key-to-index key-value pair on the storage system.

In another aspect, a device for providing traversable key-value data storage includes: one or more processors; and one or more computer-readable memories coupled to the one or more processors and having instructions stored thereon that are executable by the one or more processors to receive a first user-provided key-value pair for recordation on a storage system, the first user-provided key-value pair comprising a first user-provided key and a first user-provided value; assign a first index to the first user-provided key-value pair; generate a first index-to-key key-value pair, the first index-to-key key-value pair having a key comprising the first index and a value comprising the first user-provided key; generate a first key-to-index key-value pair, the first key-to-index key-value pair having a key comprising the first user-provided key and a value comprising the first index; and store the first user-provided key-value pair, the first index-to-key key-value pair, and the first key-to-index key-value pair on the storage system.

In still another aspect, a non-transitory computer-readable medium has stored therein instructions that, when executed by a processor of a device, cause the device to perform a method for providing traversable key-value data storage. The method includes: receiving a first user-provided key-value pair for recordation on a storage system, the first user-provided key-value pair comprising a first user-provided key and a first user-provided value; assigning a first index to the first user-provided key-value pair; generating a first index-to-key key-value pair, the first index-to-key key-value pair having a key comprising the first index and a value comprising the first user-provided key; generating a first key-to-index key-value pair, the first key-to-index key-value pair having a key comprising the first user-provided key and a value comprising the first index; and storing the first user-provided key-value pair, the first index-to-key key-value pair, and the first key-to-index key-value pair on the storage system.

### BRIEF DESCRIPTION OF THE DRAWINGS

The accompanying drawings, which are incorporated in and constitute a part of this specification, illustrate embodiments. In the following description, which refers to the drawings, the same numbers in different drawings represent the same or similar elements unless otherwise represented.

FIG. 1 is a schematic diagram of a blockchain system, according to an embodiment.

FIG. 2 is a schematic diagram of a computing device for implementing a node in a blockchain system, according to an embodiment.

FIG. 3 is a schematic diagram of a traversable key-value data storage solution, according to an embodiment.

FIG. 4 is a flow chart of a method for processing a request to traverse key-value pairs, according an embodiment.

FIG. 5 is a flow chart of a method for processing a request to retrieve a key-value pair, according an embodiment.

FIG. 6 is a flow chart of a method for processing a request to set an existing key-value pair, according an embodiment.

FIG. 7 is a flow chart of a method for processing a request to set a new key-value pair, according an embodiment.

FIG. 8 is a flow chart of a method for processing a request to delete a key-value pair, according an embodiment.

FIG. 9 is a flow chart of a method for processing a request to delete a key-value pair, according an embodiment.

FIG. 10 is a flow chart of a method for providing a traversable key-value data storage, according to an embodiment.

FIG. 11 is a block diagram of an apparatus for providing a traversable key-value data storage, according to an embodiment.

### DETAILED DESCRIPTION

Embodiments of the specification provide methods and devices for providing traversable key-value data storage on blockchains. The methods and devices utilize a key-value data structure supported by blockchain systems to provide a traversable key-value data storage solution. The methods and devices also support key-value data operations such as “get,” “set,” “delete,” and “traverse.” In some embodiments, the traversable key-value data storage solution may be provided as a library deployed on the blockchain system, allowing users to utilize the traversable key-value data storage solution through calls to the functions provided in the library.

In some embodiments, the traversable key-value data storage solution may be embedded into programs such as smart contracts or the like written to carry out various types of transactions on the blockchain system.

Embodiments disclosed in the specification have one or more technical effects. In some embodiments, the methods and devices utilize a key-value data structure supported by blockchain systems to provide a traversable key-value data storage solution. This improves the usability of the key-value data structure. In some embodiments, the methods and devices utilize the key-value data structure to define relationships between multiple key-value pairs. This provides the key-value data structure the ability to track certain types of relationship between key-value pairs stored on blockchains. In some embodiments, the methods and devices support the utilization of the traversable key-value data storage solution in programs such as smart contracts or the like. This allows the blockchain system to be more user-friendly and to effectively traverse through key-value pairs stored on the blockchain system. Practically, the methods and devices allow blockchain systems to use the key-value data structure to support data operations such as “traverse,” “get,” “set,” and “delete.”

A blockchain is a data structure that stores data, e.g., transactions, in a way that the transactions may be immutable and subsequently verified. A blockchain includes one or more blocks. Each block is linked to a previous block immediately before it in the blockchain by including a cryptographic hash of the previous block. Each block also may include a timestamp, its own cryptographic hash, and one or more transactions. The transactions, which generally have already been verified by the nodes of the blockchain system, may be hashed and encoded into a data structure, such as a Merkle tree. In a Merkle tree, data at leaf nodes of the tree is hashed, and all hashes in each branch of the tree may be concatenated at a root of the branch. This process continues up the tree to the root of the entire tree, which stores a hash that is representative of all data in the tree. A hash purporting to be of a transaction stored in the tree can be quickly verified by determining whether it is consistent with the structure of the tree.

A blockchain system includes a network of computing nodes that manage, update, and maintain one or more blockchains. The network may be a public blockchain network, a private blockchain network, or a consortium blockchain network. For example, numerous entities, such as hundreds, thousands, or even millions of entities, can operate in a public blockchain network, and each of the entities operates at least one node in the public blockchain network. Accordingly, the public blockchain network can be considered a public network with respect to the participating entities. Sometimes, a majority of entities (nodes) must sign every block for the block to be valid and added to the blockchain of the blockchain network. Examples of public blockchain networks include particular peer-to-peer payment networks that leverage a distributed ledger, referred to as blockchain.

In general, a public blockchain network may support public transactions. A public transaction is shared with all of the nodes in the public blockchain network, and is stored in a global blockchain. A global blockchain is a blockchain replicated across all nodes, and all nodes are in perfect state consensus with respect to the global blockchain. To achieve consensus (e.g., agreement to the addition of a block to a blockchain), a consensus protocol is implemented in the public blockchain network. Examples of consensus protocols include proof-of-work (POW) (e.g., implemented in the some crypto-currency networks), proof-of-stake (POS), and proof-of-authority (POA).

In general, a private blockchain network may be provided for a particular entity, which centrally controls read and write permissions. The entity controls which nodes are able to participate in the blockchain network. Consequently, private blockchain networks are generally referred to as permissioned networks that place restrictions on who is allowed to participate in the network, and on their level of participation (e.g., only in certain transactions). Various types of access control mechanisms can be used (e.g., existing participants vote on adding new entities, a regulatory authority can control admission).

In general, a consortium blockchain network may be private among the participating entities. In a consortium blockchain network, the consensus process is controlled by an authorized set of nodes, one or more nodes being operated by a respective entity (e.g., a financial institution, insurance company). For example, a consortium of ten (10) entities (e.g., financial institutions, insurance companies) can operate a consortium blockchain network, each of which operates at least one node in the consortium blockchain network. Accordingly, the consortium blockchain network can be considered a private network with respect to the participating entities. In some examples, each entity (node) must sign every block in order for the block to be validated and added to the blockchain. In some examples, at least a sub-set of entities (nodes) (e.g., at least 7 entities) must sign every block in order for the block to be validated and added to the blockchain.

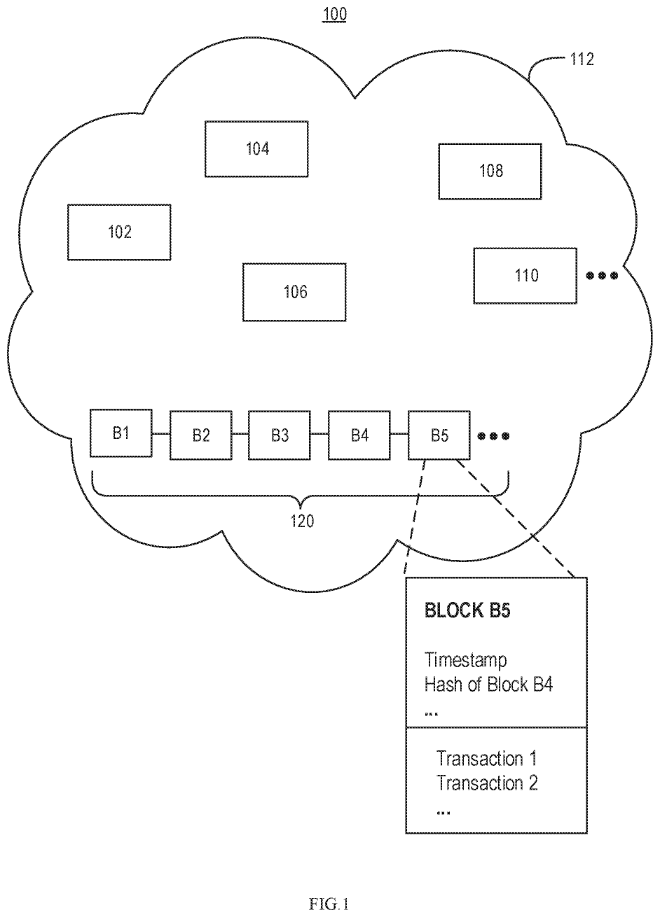

FIG. 1 illustrates a schematic diagram of a blockchain system 100, according to an embodiment. Referring to FIG. 1, the blockchain system 100 may include a plurality of nodes, e.g., nodes 102-110, configured to operate on a blockchain 120. The nodes 102-110 may form a network 112, such as a peer-to-peer (P2P) network. Each of the nodes 102-110 may be a computing device, such as a computer or a computer system, configured to store a copy of the blockchain 120, or may be software running on the computing device, such as a process or an application. Each of the nodes 102-110 may have a unique identifier.

The blockchain 120 may include a growing list of records in the form of data blocks, such as blocks B1-B5 in FIG. 1. Each of the blocks B1-B5 may include a timestamp, a cryptographic hash of a previous block, and data of the present block, which may be transactions such as monetary transactions. For example, as illustrated in FIG. 1, block B5 may include a timestamp, a cryptographic hash of block B4, and transaction data of block B5. Also, for example, a hashing operation may be performed on the previous block to generate the cryptographic hash of the previous block. The hashing operation may convert inputs of various lengths into cryptographic outputs of a fixed length through a hash algorithm, such as SHA-256.

The nodes 102-110 may be configured to perform an operation on the blockchain 120. For example, when a node, e.g., the node 102, wants to store new data onto the blockchain 120, that node may generate a new block to be added to the blockchain 120 and broadcast the new block to other nodes, e.g., the nodes 104-110, in the network 112. Based on legitimacy of the new block, e.g., validity of its signature and transactions, the other nodes may determine to accept the new block, such that the node 102 and the other nodes may add the new block to their respective copies of the blockchain 120. As this process repeats, more and more blocks of data may be added to the blockchain 120.

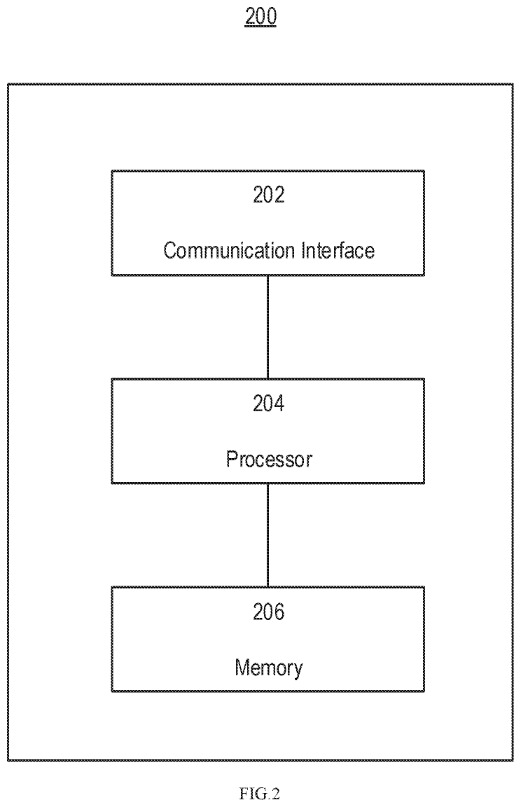

FIG. 2 illustrates a schematic diagram of a computing device 200 for implementing a node, e.g., the node 102 (FIG. 1), in a blockchain system, according to an embodiment. Referring to FIG. 2, the computing device 200 may include a communication interface 202, a processor 204, and a memory 206.

The communication interface 202 may facilitate communications between the computing device 200 and devices implementing other nodes, e.g., nodes 104-110 (FIG. 1), in the network.

In some embodiments, the communication interface 202 is configured to support one or more communication standards, such as an Internet standard or protocol, an Integrated Services Digital Network (ISDN) standard, etc. In some embodiments, the communication interface 202 may include one or more of a Local Area Network (LAN) card, a cable modem, a satellite modem, a data bus, a cable, a wireless communication channel, a radio-based communication channel, a cellular communication channel, an Internet Protocol (IP) based communication device, or other communication devices for wired and/or wireless communications. In some embodiments, the communication interface 202 may be based on public cloud infrastructure, private cloud infrastructure, hybrid public/private cloud infrastructure.

The processor 204 may include one or more dedicated processing units, application-specific integrated circuits (ASICs), field-programmable gate arrays (FPGAs), or various other types of processors or processing units. The processor 204 is coupled with the memory 206 and is configured to execute instructions stored in the memory 206.

The memory 206 may store processor-executable instructions and data, such as a copy of the blockchain 120 (FIG. 1). The memory 206 may include any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk. When the instructions in the memory 206 are executed by the processor 204, the computing device 200 may perform an operation on the blockchain 120.

Referring back to FIG. 1, the blockchain system 100 may operate according to one or more smart contracts. Each smart contract may be a computer protocol in the form of computer code that is incorporated into the blockchain 120, to facilitate, verify, or enforce the negotiation or performance of a contract. For example, a user of the blockchain system 100 may program agreed terms into a smart contract using a programming language, such as C++, Java, Solidity, Python, etc., and when the terms are met, the smart contract may be automatically executed by the blockchain system 100, e.g., to perform a transaction. Also for example, the smart contract may include a plurality of subroutines or functions, each of which may be a sequence of program instructions that performs a specific task. The smart contract may be operational code that is fully or partially executed without human interaction.

The blockchain system 100 with smart contracts may be used to record user financial information and conduct transactions including, e.g., money transfers. For example, information regarding an asset of a user and a corresponding value of that asset may be recorded on the blockchain system 100. Suppose that the user has an asset in the form of a bank account, and further suppose that the bank account has an account number of “AAAA” and a balance of “ZZZZ,” a key-value pair indicating the existence of the asset and its corresponding value may be recorded on the blockchain system 100. Recording such key-value pairs on the blockchain system 100 may enable others to verify, e.g., whether the user has adequate resources to carry out certain transactions on the blockchain system 100.

In some embodiments, a “set” operation is provided to record a key-value pair on the blockchain system 100. The “set” operation may be invoked using a function call in the format of, e.g., set(key, value), in which the account number “AAAA” may be provided as the key and the balance “ZZZZ” may be provided as the value. If the key is new, meaning that the blockchain system 100 does not have a key-value pair established for account number “AAAA” yet, then the blockchain system 100 may record a new key-value pair “AAAA”:“ZZZZ.” If the key already exists, meaning that the blockchain system 100 already has a key-value pair with “AAAA” being the key, then the blockchain system 100 may update the value that corresponds to the key to reflect an updated balance.

In some embodiments, a “get” operation is provided to retrieve the value corresponding to a key. The “get” operation may be invoked using a function call in the format of, e.g., get(key). Continuing with the example above, the function call get(“AAAA”) may be used to retrieve the value “ZZZZ” recorded for the key “AAAA.”

In some embodiments, a “delete” operation is provided to delete the value corresponding to a key. The “delete” operation may be invoked using a function call in the format of, e.g., delete(key). Continuing with the example above, the function call delete(“AAAA”) may be used to delete the key-value pair “AAAA”:“ZZZZ.”

In some embodiments, information regarding multiple assets or accounts of a user may be recorded on the blockchain system 100. For instance, the user may want to record on the blockchain system 100 information regarding multiple bank accounts. Accordingly, key-value pairs including “AAAA”:“ZZZZ,” “BBBB”:“UUUU,” “CCCC”:“0000,” “DDDD”:“YYYY,” and “EEEE”:“XXXX,” which, for example, represent account numbers and balances of five different accounts of the user, may be recorded on the blockchain system 100.

In some embodiments, a traversable key-value data storage solution may be utilized to store the key-value pairs on the blockchain system 100. The traversable key-value data storage solution may provide the ability to traverse the key-value pairs stored on the blockchain system 100 so that, e.g., all key-value pairs representing bank accounts of the user can be identified and traversed using a simple function call. Furthermore, in some embodiments, the traversable key-value data storage solution may provide the ability to determine an aggregated value representing a combined total of all bank accounts of that user. Such an aggregated value may be utilized to determine, for example, whether the user has adequate resources to carry out a transaction on the blockchain system 100.

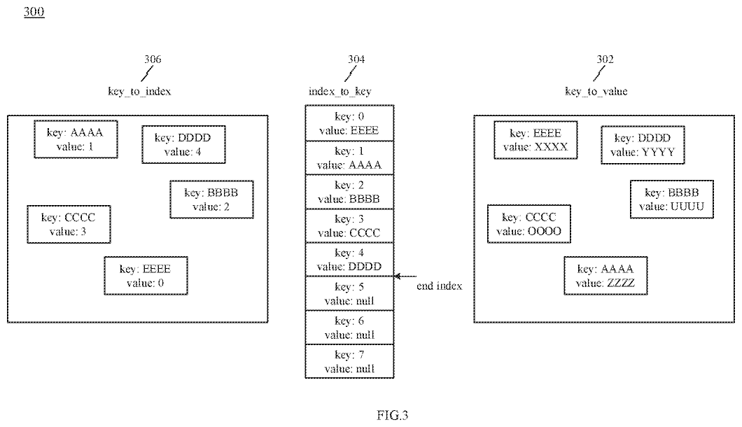

FIG. 3 is a schematic diagram of a traversable key-value data storage solution 300 for a blockchain system, e.g., the blockchain system 100 (FIG. 1), according to an embodiment. Referring to FIG. 3, the traversable key-value data storage solution 300 may include a set of key-value pairs depicted as a key-to-value set 302. The key-to-value set 302 may include user-provided key-value pairs that a user wants to record on the blockchain system 100. Continuing with the example above, the key-to-value set 302 may include key-value pairs {“AAAA”:“ZZZZ,” “BBBB”:“JUUUU,” “CCCC”:“0000,” “DDDD”:“YYYY,” “EEEE”:“XXXX”}, representing account numbers and balances of five different accounts of the user.

The traversable key-value data storage solution 300 may also include a set of system-generated index-to-key key-value pairs, referred to herein as an index-to-key set 304. For example, the traversable key-value data storage solution 300 may assign indices to the user-provided key-value pairs and instruct the blockchain system 100 to generate the index-to-key set 304 to record the indices along with their corresponding user-provided keys. The index-to-key set 304 may include, e.g., key-value pairs {0:“EEEE,”:“AAAA,” 2:“BBBB,” 3:“CCCC,” 4:“DDDD”}. In some embodiments, the ordering of the assignment of the indices may not matter. In other words, assigning the index 0 to “EEEE” and assigning the index 1 to “AAAA,” and so on, as depicted in FIG. 3, is merely provided as an example and is not meant to be limiting.

In some embodiments, the traversable key-value data storage solution 300 may start the index at a fixed starting index, e.g., 0, and increase the index sequentially for each user-provided key-value pair indexed. In some embodiments, the traversable key-value data storage solution 300 may record an end index, e.g., 4, in the example depicted in FIG. 3, for future references. The traversable key-value data storage solution 300 may utilize the recorded end index value to quickly determine a total number of user-provide keys indexed for a particular user, which in turn can provide the traversable key-value data storage solution 300 the ability to traverse through all user-provided keys for that user, as will be described in more details below. In some embodiments, the traversable key-value data storage solution 300 may record the end index as a key-value pair, e.g., END_INDEX:index.

In some embodiments, the traversable key-value data storage solution 300 may further instruct the blockchain system 100 to generate a set of key-to-index key-value pairs. The set of key-to-index key-value pairs, referred to as the key-to-index set 306 in FIG. 3, may be generated by inverting the key-value pairs in the index-to-key set 304. Continuing with the example above, the traversable key-value data storage solution 300 may instruct the blockchain system 100 to generate key-to-index key-value pairs {“AAAA”:1, “BBBB”:2, “CCCC”:3, “DDDD”:4, “EEEE”:0}. In this manner, the system-generated key-value pairs in the index-to-key set 304 and the system-generated key-value pairs in the key-to-index set 306 can jointly form a bidirectional mapping between user-provided keys, e.g., “AAAA,” “BBBB,” “CCCC,” “DDDD,” and “EEEE,” and their assigned indices, e.g., 1, 2, 3, 4, and 0, respectively.

In some embodiments, the traversable key-value data storage solution 300 may store all key-value pairs on one or more nodes, e.g., the nodes 102-110, of the blockchain system 100 (FIG. 1), regardless of whether the key-value pairs are provided by users or generated by the blockchain system 100. For illustrative purposes only, the key-to-value set 302, the index-to-key set 304, and the key-to-index set 306 are depicted separately in FIG. 3.

In some embodiments, the traversable key-value data storage solution 300 may utilize concatenations, e.g., prefixes or suffixes, to uniquely identify the various key-value pairs stored on the blockchain system 100. For example, the traversable key-value data storage solution 300 may instruct the blockchain system 100 to store the user-provided key-value pairs {“AAAA”:“ZZZZ,” “BBBB”:“UUUU,” “CCCC”:“0000,” “DDDD”:“YYYY,” “EEEE”:“XXXX”} as, e.g.,

{“USERID_KEY_TO_VALUE_AAAA”:“ZZZZ,”

“USERIDKEY_TO_VALUE_BBBB”:“UUUU,”

“USERID_KEY_TO_VALUE_CCCC”:“OOOO,”

“USERID_KEY_TO_VALUE_DDDD”:“YYYY,”

“USERID_KEY_TO_VALUE_EEEE”:“XXXX”}.

It is noted that the original user-provided keys are still included in the keys after applying the prefixes. It is also noted that the “USERID” prefix may be a variable that can change based on an identifier associated the user providing the key-value pairs. In this manner, the traversable key-value data storage solution 300 can use the “USERID” prefix to differentiate key-value pairs provided by different users. The “KEY_TO_VALUE” prefix may be a type indicator used to indicate that these key-value pairs comprise records of user-provided key-value pairs, which are different from system-generated key-value pairs.

Similarly, the traversable key-value data storage solution 300 may instruct the blockchain system 100 to store the system-generated key-value pairs {0:“EEEE,”:“AAAA,” 2:“BBBB,” 3:“CCCC,” 4:“DDDD”) as, e.g.,

(“USERID_INDEX_TO_KEY_0”:“EEEE,”

“USERID_INDEX_TO_KEY_1”:“AAAA,”

“USERID_INDEX_TO_KEY_2”:“BBBB,”

“USERID_INDEX_TO_KEY_3”:“CCCC,”

“USERID_INDEX_TO_KEY_4”:“DDDD”),

and the system-generated key-value pairs (“AAAA”:1, “BBBB”:2, “CCCC”:3, “DDDD”:4, “EEEE”:0} as, e.g.,

{“USERID_KEY_TO_INDEX_AAAA”:1,

“USERID_KEY_TO_INDEX_BBBB”:2,

“USERIDKEY_TO_INDEX_CCCC”:3,

“USERID_KEY_TO_INDEX_DDDD”:4,

“USERID_KEY_TO_INDEX_EEEE”:0}.

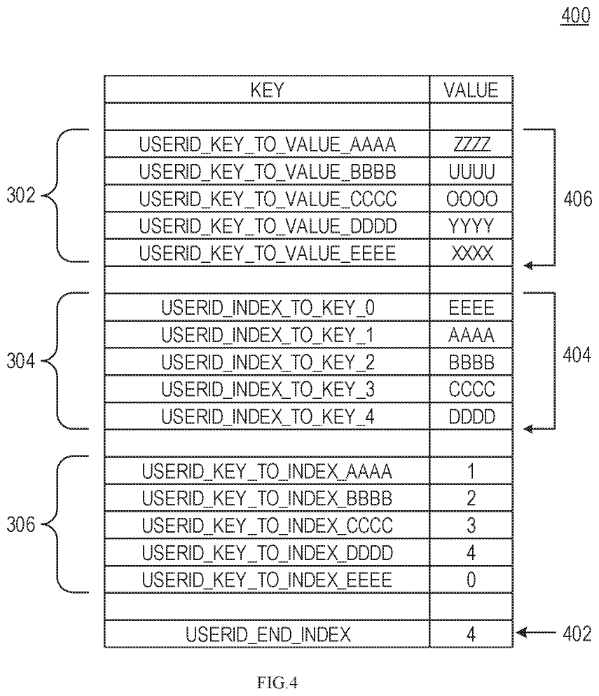

In this manner, the traversable key-value data storage solution 300 may utilize prefixes to uniquely identify the various key-value pairs stored on the blockchain system 100, eliminating the need to require a special data structure for tracking and maintaining the key-to-value set 302, the index-to-key set 304, and the key-to-index set 306. FIG. 4 provides an illustration depicting the various key-value pairs as they are stored on the blockchain system 100. Storing the key-value pairs in this manner allows the traversable key-value data storage solution 300 to support various types of data operations including, e.g., “traverse,” “get,” “set,” and “delete.”

In some embodiments, the traversable key-value data storage solution 300 may provide the various data operations in a library deployed on the blockchain system 100, allowing users to utilize the traversable key-value data storage solution 300 through calls to functions provided in the library. In some embodiments, the traversable key-value data storage solution 300 may provide a programming interface to receive function calls from programs executing on the blockchain system 100, including smart contracts and the like.

FIG. 4 illustrates a flow chart of a method 400 for processing a request to traverse key-value pairs, according to an embodiment. The method 400 may be performed on one or more nodes, e.g., the nodes 102-110, of the blockchain system 100 (FIG. 1). In the embodiment, it is assumed that a user wants to traverse through all accounts of USERID (which may identify the user himself, or another user, depending on the specific use case). Accordingly, the user may use a function call in the format of, e.g., traverse(USERID), to call a “traverse” function provided by the traversable key-value data storage solution 300. Upon receiving the call, the traversable key-value data storage solution 300 may proceed to traverse through all accounts of USERID using the method 400.

At step 402, the traversable key-value data storage solution 300 may determine a list of indices assigned to key-value pairs provided by USERID. For example, as illustrated in FIG. 4, the traversable key-value data storage solution 300 may determine that all indices i through j, where i=start index 0 and j=end index 4, have been assigned to key-value pairs provided by USERID.

At step 404, the traversable key-value data storage solution 300 may traverse through key-value pairs contained in the index-to-key set 304 to obtain a list of user-provided keys (which are stored as values in the key-value pairs contained in the index-to-key set 304). For example, as illustrated in FIG. 4, the traversable key-value data storage solution 300 may traverse through the key-value pairs contained in the index-to-key set 304 using keys USERID_INDEX_TO_KEY_i through USERID_INDEX_TO_KEY_j, where i=start index 0 and j=end index 4, to obtain a list of user-provided keys “EEEE,” “AAAA,” “BBBB,” “CCCC,” and “DDDD.”

At step 406, the traversable key-value data storage solution 300 may traverse through key-value pairs contained in the key-to-value set 302 based on the list of user-provided keys obtained in step 404. For example, as illustrated in FIG. 4, the traversable key-value data storage solution 300 may traverse through key-value pairs contained in the key-to-value set 302 using keys “USERID_KEY_TO_VALUE_” concatenated with “AAAA,” “BBBB,” “CCCC,” “DDDD,” and “EEEE.” The traversable key-value data storage solution 300 may obtain a list of values “ZZZZ,” “UUUU,” “OOOO,” “YYYY,” and “XXXX,” respectively, and complete the “traverse” function call.

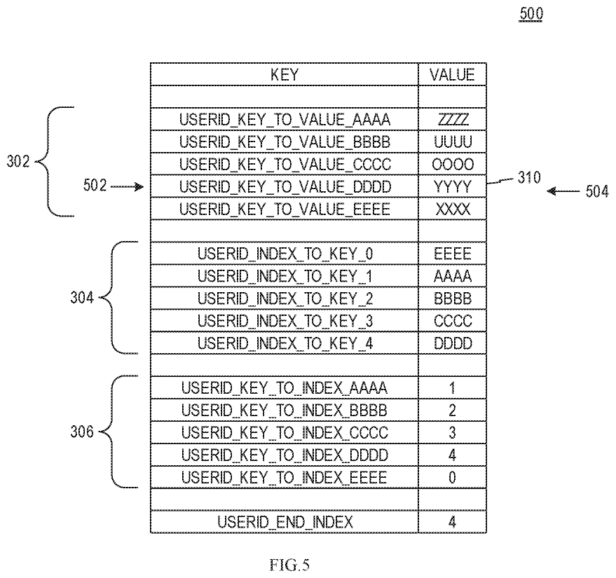

FIG. 5 illustrates a flow chart of a method 500 for processing a request to retrieve key-value pairs, according to an embodiment. The method 500 may be performed on one or more nodes, e.g., the nodes 102-110, of the blockchain system 100 (FIG. 1). In the embodiment, it is assumed that a user wants to verify whether a particular account, e.g., “DDDD,” of USERID (which may identify the user himself, or another user, depending on the specific use case) has sufficient balance to facilitate a money transfer. Accordingly, the user may use a function call in the format of, e.g., get(USERID, DDDD), to call a “get” function provided by the traversable key-value data storage solution 300. Upon receiving the call, the traversable key-value data storage solution 300 may proceed to retrieve the requested key-value pair using the method 500.

At step 502, the traversable key-value data storage solution 300 may construct a key to be utilized to retrieve the requested key-value pair based on the prefix rule described above. For example, as illustrated in FIG. 5, the traversable key-value data storage solution 300 may construct the key as “USERID_KEY_TO_VALUE_DDDD.” The “USERID” prefix can be utilized to identify the user who provided the requested key-value pair. The “KEY_TO_VALUE” prefix can be utilized to indicate that the key-value pair should be retrieved from the key-to-value set 302. The account number “DDDD” provided in the “get” function call is included as a part of the key to indicate which specific key-value pair in the key-to-value set 302 should be retrieved.

At step 504, the traversable key-value data storage solution 300 may retrieve, from the key-to-value set 302, a key-value pair that has a key matching the constructed key. For example, as illustrated in FIG. 5, the traversable key-value data storage solution 300 may retrieve the key-value pair 310. In some embodiments, the traversable key-value data storage solution 300 may return the key-value pair 310 to complete the “get” function call. Alternatively or additionally, the traversable key-value data storage solution 300 may obtain the value “YYYY” from the key-value pair 310 and return the value to complete the “get” function call.

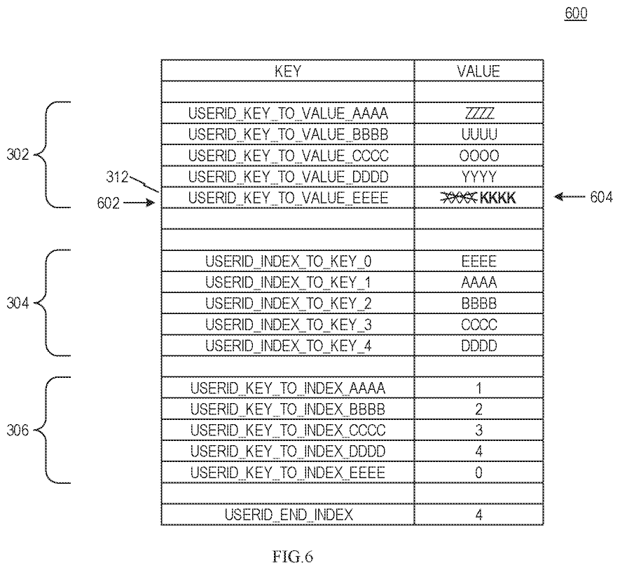

FIG. 6 illustrates a flow chart of a method 600 for processing a request to set the value of an existing key-value pair, according to an embodiment. The method 600 may be performed on one or more nodes, e.g., the nodes 102-110, of the blockchain system 100 (FIG. 1). In the embodiment, it is assumed that a key-value pair 312 is already recorded on the blockchain system 100, and a user wants to update the value recorded in the key-value pair 312 to “KKKK” after carrying out a money transfer transaction. Accordingly, the user may use a function call in the format of, e.g., set(USERID, EEEE, KKKK), to call a “set” function provided by the traversable key-value data storage solution 300. Upon receiving the call, the traversable key-value data storage solution 300 may proceed to set the value for the key-value pair using the method 600.

At step 602, the traversable key-value data storage solution 300 may construct a key, e.g., “USERID_KEY_TO_VALUE_EEEE,” based on the prefix rule described above and use the key to locate the key-value pair 312.

At step 604, the traversable key-value data storage solution 300 may set the value of the key-value pair 312 according to the new value provided in the “set” function. For example, as illustrated in FIG. 6, the traversable key-value data storage solution 300 sets the value of the key-value pair 312 to “KKKK” as specified in the “set” function call. Upon completion of this operation, the key-value pair 312 will have the value “KKKK” stored for the key “USERID_KEY_TO_VALUE_EEEE,” representing the updated balance of the account after carrying out the money transfer transaction.

In some embodiments, the user may also use the “set” function to set a value of a new account on the blockchain system 100. Setting a value of a new account may require the traversable key-value data storage solution 300 to record a new user-provided key-value pair on the blockchain system 100.

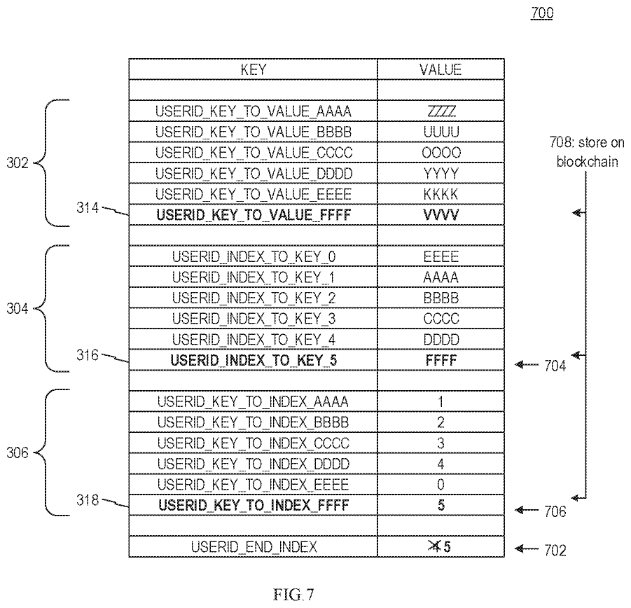

FIG. 7 illustrates a flow chart of a method 700 for processing a request to set a new key-value pair, according to an embodiment. The method 700 may be performed on one or more nodes, e.g., the nodes 102-110, of the blockchain system 100 (FIG. 1). In the embodiment, it is assumed that a user wants to record a key-value pair representing a value of “VVVV” for a new account “FFFF” on the blockchain system 100. Accordingly, the user may use a function call in the format of, e.g., set(USERID, FFFF, VVVV), to call the “set” function provided by the traversable key-value data storage solution 300. Upon receiving the call, the traversable key-value data storage solution 300 may construct a key, e.g., “USERID_KEY_TO_VALUE_FFFF,” based on the prefix rule described above and attempt to locate a key-value pair with the key being “USERID_KEY_TO_VALUE_FFFF.” If the traversable key-value data storage solution 300 locates such a key-value pair, the traversable key-value data storage solution 300 may proceed to set the value for that key-value pair using the method 600. On the other hand, if the traversable key-value data storage solution 300 cannot locate such a key-value pair, meaning that none of the key-value pairs in the key-to-value set 302 has a key that comprises the account number “FFFF,” the traversable key-value data storage solution 300 may proceed to record the key-value pair as a new key-value pair 314 on the blockchain system 100 using the method 700.

At step 702, the traversable key-value data storage solution 300 may assign an index to the new key-value pair 314. In some embodiments, the traversable key-value data storage solution 300 may determine the index to be assigned to the new key-value pair 314 based on the end index recorded for the user providing the new key-value pair. For example, as illustrated in FIG. 7, the end index recorded for the user providing the new key-value pair is 4 (recorded in key-value pair USERID_END_INDEX:4), so the traversable key-value data storage solution 300 may sequentially increase the end index by one and assign the increased index, e.g., 5, to the new key-value pair 314.

At step 704, the traversable key-value data storage solution 300 may instruct the blockchain system 100 to generate an index-to-key key-value pair 316. The key of the key-value pair 316 may be set to include the index assigned to the new key-value pair 314 and the value of the key-value pair 316 may be set to include the user-provided key specified in the new key-value pair 314. For example, as illustrated in FIG. 7, the key of the key-value pair 316 may be set to include the index 5 and the value of the key-value pair 316 may be set to include the account number “FFFF.” In some embodiments, the traversable key-value data storage solution 300 may instruct the blockchain system 100 to follow the same prefix rules described above when generating the key-value pair 316. In such embodiments, the key of the key-value pair 316 may be set to “USERID_INDEX_TO_KEY_5” and the key-value pair 316 may therefore be provided as “USERID_INDEX_TO_KEY_5”:“FFFF.”

At step 706, the traversable key-value data storage solution 300 may instruct the blockchain system 100 to generate a key-to-index key-value pair 318. The key of the key-value pair 318 may be set to include the key specified in the new key-value pair 314 and the value of the key-value pair 318 may be set to include the index assigned to the new key-value pair 314. For example, as illustrated in FIG. 7, the key of the key-value pair 318 may be set to include the account number “FFFF” and the value of the key-value pair 318 may be set to include the index 5. In some embodiments, the traversable key-value data storage solution 300 may instruct the blockchain system 100 to follow the same prefix rules described above when generating the key-value pair 318. In such embodiments, the key of the key-value pair 318 may be set to “USERID_KEY_TO_INDEX_FFFF” and the key-value pair 318 may therefore be provided as “USERID_KEY_TO_INDEX_FFFF”:5.

At step 708, the traversable key-value data storage solution 300 may store the new key-value pair 314, the index-to-key key-value pair 316, and the key-to-index key-value pair 318 on the blockchain system 100 to complete the “set” function call.

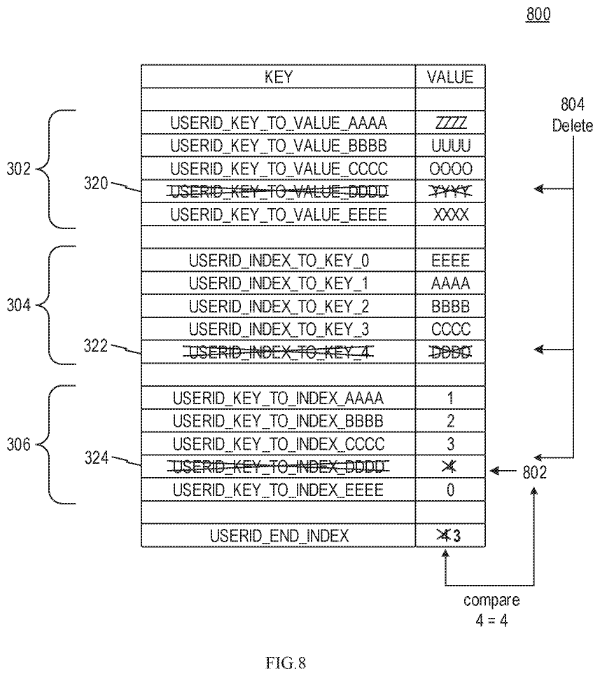

In some embodiments, the traversable key-value data storage solution 300 may provide users abilities to delete key-value pairs stored on the blockchain system 100. FIG. 8 illustrates a flow chart of a method 800 for processing a request to delete a key-value pair, according to an embodiment. The method 800 may be performed on one or more nodes, e.g., the nodes 102-110, of the blockchain system 100 (FIG. 1). In the embodiment, it is assumed that a user wants to delete information regarding account “DDDD.” Accordingly, the user may use a function call in the format of, e.g., delete(USERID, DDDD), to call a “delete” function provided by the traversable key-value data storage solution 300. Upon receiving the call, the traversable key-value data storage solution 300 may construct a key, e.g., “USERID_KEY_TO_VALUE_DDDD,” based on the prefix rule described above and attempt to locate a key-value pair with the key being “USERID_KEY_TO_VALUE_DDDD.” If the traversable key-value data storage solution 300 cannot locate such a key-value pair, the traversable key-value data storage solution 300 may report an error. On the other hand, if the traversable key-value data storage solution 300 locates such a key-value pair, e.g., the key-value pair 320 as depicted in FIG. 8, the traversable key-value data storage solution 300 may proceed to delete the key-value pair 320 using the method 800.

At step 802, the traversable key-value data storage solution 300 may determine whether the index assigned to the key-value pair 320 is at the end of an indexing sequence used to index the key-value pairs in the key-value set 302. In some embodiments, the traversable key-value data storage solution 300 may determine the index assigned to the key-value pair 320 by retrieving the value contained in the key-value pair 324 with the key being “USERID_KEY_TO_INDEX_DDDD.” For example, as illustrated in FIG. 8, the traversable key-value data storage solution 300 may determine that the index assigned to the key-value pair 320 is 4. The traversable key-value data storage solution 300 may also use the index to locate a key-value pair 322. For example, the traversable key-value data storage solution 300 may use “USERID_INDEX_TO_KEY_4” as the key to locate the key-value pair 322.

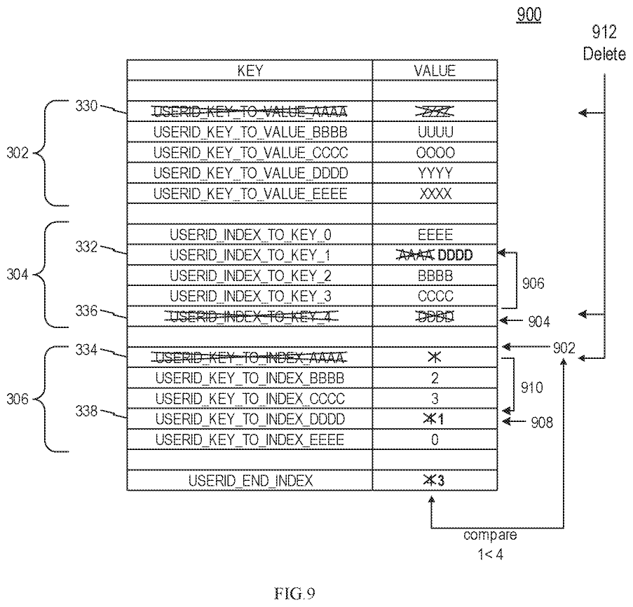

The traversable key-value data storage solution 300 may compare the index assigned to the key-value pair 320 with the end index recorded in USERID_END_INDEX to determine whether the index assigned to the key-value pair 320 is at the end of the indexing sequence. If the traversable key-value data storage solution 300 determines that the index assigned to the key-value pair 320 is at the end of the indexing sequence, the traversable key-value data storage solution 300 may delete the key-value pair 320 and its corresponding system-generated key-value pairs 324 and 322 at step 804 and decrease the recorded end index value for USERID_END_INDEX by one to complete the “delete” function call. On the other hand, if the traversable key-value data storage solution 300 determines that the index assigned to the key-value pair 320 is not at the end of the indexing sequence, the traversable key-value data storage solution 300 may rearrange the indexing sequence to avoid creating a gap in the indexing sequence. The rearrangement of the indexing sequence is illustrated in FIG. 9.

FIG. 9 illustrates a flow chart of a method 900 for processing a request to delete a key-value pair when the key-value pair is not at the end of the indexing sequence, according to an embodiment. The method 900 may be performed on one or more nodes, e.g., the nodes 102-110, of the blockchain system 100 (FIG. 1). In the embodiment, it is assumed that a user wants to delete information regarding account “AAAA.” Accordingly, the user may use a function call in the format of, e.g., delete(USERID, AAAA), to call the “delete” function provided by the traversable key-value data storage solution 300. Upon receiving the call, the traversable key-value data storage solution 300 may construct a key, e.g., “USERID_KEY_TO_VALUE_AAAA,” based on the prefix rule described above and attempt to locate a key-value pair with the key being “USERID_KEY_TO_VALUE_AAAA.” If the traversable key-value data storage solution 300 cannot locate such a key-value pair, the traversable key-value data storage solution 300 may report an error. On the other hand, if the traversable key-value data storage solution 300 locates such a key-value pair, e.g., the key-value pair 330 as depicted in FIG. 9, the traversable key-value data storage solution 300 may proceed to delete the key-value pair 330 using the method 900.

At step 902, the traversable key-value data storage solution 300 may determine whether the index assigned to the key-value pair 330 is at the end of the indexing sequence. In some embodiments, the traversable key-value data storage solution 300 may determine the index assigned to the key-value pair 330 by retrieving the value contained in the key-value pair 334 with the key being “USERID_KEY_TO_INDEX_AAAA.” For example, as illustrated in FIG. 9, the traversable key-value data storage solution 300 may determine that the index assigned to the key-value pair 330 is 1. The traversable key-value data storage solution 300 may also use the index to locate a key-value pair 332. For example, the traversable key-value data storage solution 300 may use “USERID_INDEX_TO_KEY_1” as the key to locate the key-value pair 332.

The traversable key-value data storage solution 300 may compare the index assigned to the key-value pair 330 with the end index recorded in USERID_END_INDEX to determine whether the index assigned to the key-value pair 330 is at the end of the indexing sequence. Because the index assigned to the key-value pair 330 is not at the end of the indexing sequence, the traversable key-value data storage solution 300 may need to rearrange the indexing sequence to avoid creating a gap in the indexing sequence.

In some embodiments, the traversable key-value data storage solution 300 may identify a key-value pair 336 as being at the end of the indexing sequence at step 904 and replace the value of the key-value pair 332 with the value contained in the key-value pair 336 at step 906. The key-value pair 336 may also be referred to as a replacement index-to-key key-value pair. In some embodiments, the traversable key-value data storage solution 300 may identify the key-value pair 336 as being at the end of the indexing sequence because the recorded end index is 4, which is included in the key of the key-value pair 336. Because the key-value pair 336 is at the end of the indexing sequence, it can be removed without creating any gaps in the indexing sequence.

In some embodiments, the traversable key-value data storage solution 300 may identify a key-value pair 338 as being affected by this rearrangement at step 908 and set the value of the key-value pair 338 from 4 to 1 (which corresponds to the index assigned to the key-value pair 330) at step 910. The key-value pair 338 may also be referred to as a replacement key-to-index key-value pair. The traversable key-value data storage solution 300 may identify the key-value pair 338 as being affected based on its key “USERID_KEY_TO_INDEX_DDDD” including the value “DDDD” contained in the key-value pair 336. The traversable key-value data storage solution 300 may set the value of the key-value pair 338 from 4 to 1 to reflect the fact that “DDDD” has been re-assigned 1 as its new index. The traversable key-value data storage solution 300 may decrease the recorded end index value for USERID_END_INDEX by one and delete the key-value pairs 330, 334, and 336 at step 912 to complete the “delete” function.

It is to be understood that the traversable key-value data storage solution 300 may be implemented using various types of programming languages and that the declarations of the various functions described above are merely provided as examples and are not meant to be limiting. For example, the “traverse,” “get,”, “set,” and “delete” operations described above may be declared differently, e.g., with different function names or different listings of parameters, while still able to perform the same operations described above.

It is also to be understood that the prefix rules described above are merely provided as examples and are not meant to be limiting. Other concatenation techniques, such as appending suffixes and the like, may be utilized as long as the traversable key-value data storage solution 300 can uniquely identify the various key-value pairs stored on the blockchain system 100. In some embodiments, prefix rules (or other concatenation rules) may be provided to support additional indicators. For example, if bank accounts can be associated with both balance values and credit values, then the prefix rules can be defined to support recordation of both values. The balance values may be recorded using prefixes defined as, e.g.,

BALANCE_<USERID>_KEY_TO_VALUE_<ACCOUNT_NUMBER>,

BALANCE_<USERID>_INDEX_TO_KEY_<ACCOUNT_NUMBER>,

BALANCE_<USERID>_KEY_TO_INDEX_<ACCOUNT_NUMBER>, and

BALANCE_<USERID>_END_INDEX,

and the credit values may be recorded using prefixes defined as, e.g.,

CREDIT_<USERID>_KEY_TO_VALUE_<ACCOUNT_NUMBER>,

CREDIT_<USERID>_INDEX_TO_KEY_<ACCOUNT_NUMBER>,

CREDIT_<USERID>_KEY_TO_INDEX_<ACCOUNT_NUMBER>, and

CREDIT_<USERID>_END_INDEX.

In this manner, if users want to operate on balance values, the users may indicate, e.g., using function parameters, that the “BALANCE” prefix should be used when performing the operations described above. On the other hand, if the users want to operate on credit values, the users may indicate that the “CREDIT” prefix should be used when performing the operations described above. It is contemplated that such prefix rules (or other concatenation rules) may be further expanded as needed.

Furthermore, it is to be understood that the traversable key-value data storage solution 300 described above may be implemented in storage systems that are not a part of a blockchain system. It is contemplated that the traversable key-value data storage solution 300 may be implemented in any storage systems capable of supporting key-value pair data storage.

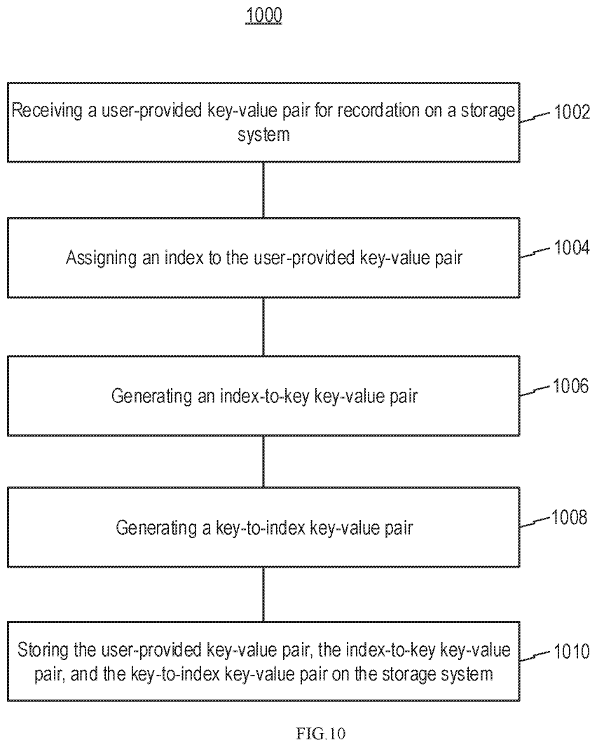

FIG. 10 illustrates a flow chart of a method 1000 for providing traversable key-value data storage according to an embodiment. The method 1000 may be performed by one or more nodes, e.g., the nodes 102-110, of the blockchain system 100 (FIG. 1).

At step 1002, a node, e.g., the node 102, may receive a user-provided key-value pair for recordation on a storage system, e.g., the blockchain system 100. The user-provided key-value pair may include a user-provided key and a user-provided value. At step 1004, the node 102 may assigning an index to the user-provided key-value pair. In some embodiments, the node 102 may determine the index to be assigned to the user-provided key-value pair based on an end index recorded for the user.

At step 1006, the node 102 may generate an index-to-key key-value pair. The key of the index-to-key key-value pair may be set to include the index assigned to the user-provided key-value pair. The value of the index-to-key key-value pair may be set to include the user-provided key specified in the user-provided key-value pair. At step 1008, the node 102 may generate a key-to-index key-value pair. The key of the key-to-index key-value pair may be set to include the user-provided key specified in the user-provided key-value pair. The value of the key-to-index key-value pair may be set to include the index assigned to the user-provided key-value pair. At step 1010, the node 102 may store the user-provided key-value pair, the index-to-key key-value pair, and the key-to-index key-value pair on the storage system, e.g., the blockchain system 100.

In some embodiments, the node 102 may provide a programming interface to receive data requests, e.g., from smart contracts executing on the blockchain system 100. In some embodiments, the data requests may be in the form of function calls.

In some embodiments, the data requests may include a request to traverse key-value pairs. The node 102 may utilize the method 400 (FIG. 4) to process the traverse request. In some embodiments, the data requests may include a request to retrieve a key-value pair. The node 102 may utilize the method 500 (FIG. 5) to process the retrieve request. In some embodiments, the data requests may include a request to record a key-value pair. If the key-value pair exists on the storage system, the node 102 may utilize the method 600 (FIG. 6) to process the request and set the value of the existing key-value pair. If the key-value pair does not exist on the storage system, the node 102 may utilize the method 700 (FIG. 7) to process the request and record a new key-value pair on the storage system. In some embodiments, the data requests may include a request to delete a key-value pair. If the key-value pair is indexed at the end of an indexing sequence, the node 102 may utilize the method 800 (FIG. 8) to process the request and delete the key-value pair. If the key-value pair is not indexed at the end of an indexing sequence, the node 102 may utilize the method 900 (FIG. 9) to process the request and delete the key-value pair.

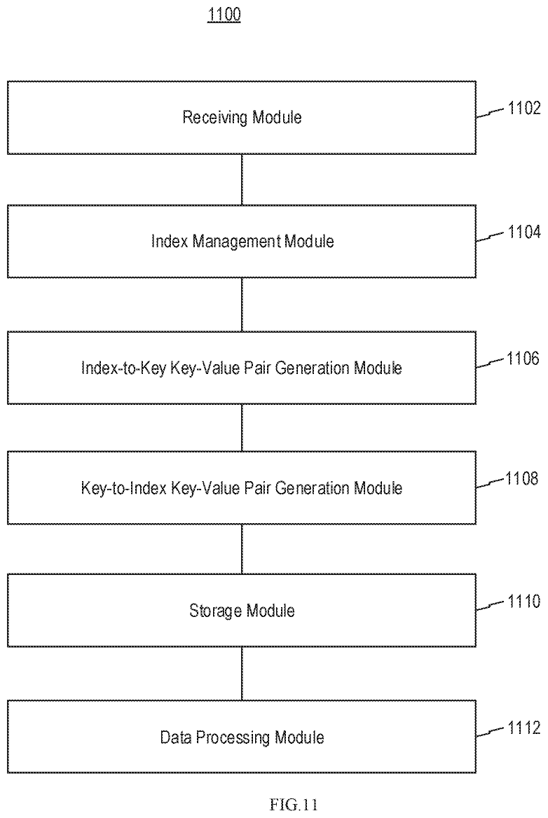

FIG. 11 is a block diagram of an apparatus 1100 for providing traversable key-value data storage according to an embodiment. For example, the apparatus 1100 may be an implementation of a software process, and may correspond to the method 1000 (FIG. 10). Referring to FIG. 11, the apparatus 1100 may include a receiving module 1102, an index management module 1104, an index-to-key key-value pair generation module 1106, a key-to-index key-value pair generation module 1108, a storage module 1110, and a data processing module 1112.

The receiving module 1102 may receive a user-provided key-value pair for recordation on a storage system, e.g., the blockchain system 100 (FIG. 1). The index management module 1104 may assign an index to the user-provided key-value pair.

The index-to-key key-value pair generation module 1106 may generate an index-to-key key-value pair for the user-provided key-value pair. The key of the index-to-key key-value pair may be set to include the index assigned to the user-provided key-value pair. The value of the index-to-key key-value pair may be set to include the user-provided key specified in the user-provided key-value pair. The key-to-index key-value pair generation module 1108 may generate a key-to-index key-value pair for the user-provided key-value pair. The key of the key-to-index key-value pair may be set to include the user-provided key specified in the user-provided key-value pair. The value of the key-to-index key-value pair may be set to include the index assigned to the user-provided key-value pair. The storage module 1110 may store the user-provided key-value pair, the index-to-key key-value pair, and the key-to-index key-value pair on the storage system, e.g., the blockchain system 100.

The data processing module 1112 may provide a programming interface to receive data requests, e.g., from smart contracts executing on the blockchain system 100. In some embodiments, the data requests may be in the form of function calls. In some embodiments, the data requests may include a request to traverse key-value pairs. The data processing module 1112 may utilize the method 400 (FIG. 4) to process the traverse request. In some embodiments, the data requests may include a request to retrieve a key-value pair. The data processing module 1112 may utilize the method 500 (FIG. 5) to process the retrieve request. In some embodiments, the data requests may include a request to record a key-value pair. If the key-value pair exists on the storage system, the data processing module 1112 may utilize the method 600 (FIG. 6) to process the request and set the value of the existing key-value pair. If the key-value pair does not exist on the storage system, the data processing module 1112 may utilize the method 700 (FIG. 7) to process the request and record a new key-value pair on the storage system. In some embodiments, the data requests may include a request to delete a key-value pair. If the key-value pair is indexed at the end of an indexing sequence, the data processing module 1112 may utilize the method 800 (FIG. 8) to process the request and delete the key-value pair. If the key-value pair is not indexed at the end of an indexing sequence, the data processing module 1112 may utilize the method 900 (FIG. 9) to process the request and delete the key-value pair.

Each of the above described modules may be implemented as software, or hardware, or a combination of software and hardware. For example, each of the above described modules may be implemented using a processor executing instructions stored in a memory. Also, for example, each the above described modules may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the described methods. Further for example, each of the above described modules may be implemented by using a computer chip or an entity, or implemented by using a product having a certain function. In one embodiment, the apparatus 1100 may be a computer, and the computer may be a personal computer, a laptop computer, a cellular phone, a camera phone, a smartphone, a personal digital assistant, a media player, a navigation device, an email receiving and sending device, a game console, a tablet computer, a wearable device, or any combination of these devices.

For an implementation process of functions and roles of each module in the apparatus 1100, references can be made to corresponding steps in the above-described methods. Details are omitted here for simplicity.

In some embodiments, a computer program product may include a non-transitory computer-readable storage medium having computer-readable program instructions thereon for causing a processor to carry out the above-described methods.

The computer-readable storage medium may be a tangible device that can store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The computer-readable program instructions for carrying out the above-described methods may be assembler instructions, instruction-set-architecture (ISA) instructions, machine instructions, machine dependent instructions, microcode, firmware instructions, state-setting data, or source code or object code written in any combination of one or more programming languages, including an object oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The computer-readable program instructions may be provided to a processor of a general-purpose or special-purpose computer, or other programmable data processing apparatus to produce a machine, such that the instructions, which execute via the processor of the computer or other programmable data processing apparatus, create means for implementing the above-described methods.

The flow charts and diagrams in the figures illustrate the architecture, functionality, and operation of possible implementations of devices, methods, and computer program products according to various embodiments of the specification. In this regard, a block in the flow charts or diagrams may represent a software program, segment, or portion of code, which comprises one or more executable instructions for implementing specific functions. It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the diagrams and/or flow charts, and combinations of blocks in the diagrams and flow charts, may be implemented by special purpose hardware-based systems that perform the specified functions or acts, or combinations of special purpose hardware and computer instructions.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

Although the specification has been described in conjunction with specific embodiments, many alternatives, modifications and variations will be apparent to those skilled in the art. Accordingly, the following claims embrace all such alternatives, modifications and variations that fall within the terms of the claims.

1. A computer-implemented method for providing traversable key-value data storage, the method comprising:
receiving a first user-provided key-value pair for recordation on a storage system, the first user-provided key-value pair comprising a first user-provided key and a first user-provided value;
assigning a first index to the first user-provided key-value pair;
generating a first index-to-key key-value pair, the first index-to-key key-value pair being separate from the first user-provided key-value pair, the first index-to-key key-value pair having a key comprising the first index assigned to the first user-provided key-value pair and a value comprising the first user-provided key in the first user-provided key-value pair;
generating a first key-to-index key-value pair, the first key-to-index key-value pair being separate from the first index-to-key key-value pair and the first user-provided key-value pair, the first key-to-index key-value pair having a key comprising the first user-provided key in the first user-provided key-value pair and a value comprising the first index assigned to the first user-provided key-value pair;
storing the first user-provided key-value pair, the first index-to-key key-value pair, and the first key-to-index key-value pair on the storage system; and
facilitating a data operation on the first user-provided key-value pair based on at least one of the first index-to-key key-value pair or the first key-to-index key-value pair stored on the storage system.

2. The method of claim 1, further comprising:
providing the traversable key-value data storage on a blockchain; and
providing a programming interface to receive a data request from a smart contract executing on the blockchain.

3. The method of claim 1, further comprising:
receiving a request to traverse through a plurality of user-provided key-value pairs stored on the storage system;
determining a list of indices assigned to the plurality of user-provided key-value pairs;
traversing through a plurality of index-to-key key-value pairs based on the list of indices to obtain a list of user-provided keys; and
traversing through the plurality of user-provided key-value pairs based on the obtained list of user-provided keys.

4. The method of claim 1, further comprising:
receiving a second user-provided key-value pair for recordation on the storage system, the second user-provided key-value pair comprising a second user-provided key and a second user-provided value;
determining whether any user-provided key-value pair stored on the storage system comprises a user-provided key matching the second user-provided key; and
in response to a determination that a particular user-provided key-value pair stored on the storage system comprises a user-provided key matching the second user-provided key, setting the second user-provided value as the value for the particular user-provided key-value pair.

5. The method of claim 4, further comprising:
in response to a determination that no user-provided key-value pair stored on the storage system comprises a user-provided key matching the second user-provided key, processing the second user-provided key-value pair for recordation on the storage system.

6. The method of claim 5, wherein the processing the second user-provided key-value pair for recordation on the storage system further comprises:
assigning a second index to the second user-provided key-value pair;
generating a second index-to-key key-value pair, the second index-to-key key-value pair having a key comprising the second index and a value comprising the second user-provided key;
generating a second key-to-index key-value pair, the second key-to-index key-value pair having a key comprising the second user-provided key and a value comprising the second index; and
storing the second user-provided key-value pair, the second index-to-key key-value pair, and the second key-to-index key-value pair on the storage system.

7. The method of claim 1, further comprising:
receiving a request to delete the first user-provided key-value pair;
determining whether the first index assigned to the first user-provided key-value pair is at an end of an indexing sequence; and
in response to a determination that the first index is at the end of the indexing sequence, deleting the first user-provided key-value pair, the first index-to-key key-value pair, and the first key-to-index key-value pair from the storage system.

8. The method of claim 7, further comprising:
in response to a determination that the first index is not at the end of the indexing sequence, rearranging the indexing sequence.

9. The method of claim 8, wherein the rearranging the indexing sequence further comprises:
identifying a replacement index-to-key key-value pair, the replacement index-to-key key-value pair having been indexed at the end of the indexing sequence;
replacing the value of the first index-to-key key-value pair with a value contained in the replacement index-to-key key-value pair;
identifying a replacement key-to-index key-value pair, the replacement key-to-index key-value pair having a key comprising the value contained in the replacement index-to-key key-value pair;
setting the first index as the value of the replacement key-to-index key-value pair; and
deleting the first user-provided key-value pair, the replacement index-to-key key-value pair, and the first key-to-index key-value pair from the storage system.

10. The method of claim 2, wherein the data request comprises at least one of: a request to record a user-provided key-value pair, a request to retrieve a user-provided key-value pair, a request to delete a user-provided key-value pair, or a request to traverse through user-provided key-value pairs stored on the blockchain.

11. The method of claim 1, further comprising:
concatenating a key contained in a user-provided key-value pair, a key contained in an index-to-key key-value pair, and a key contained in a key-to-index key-value pair according to a concatenation rule.

12. The method of claim 11, wherein the concatenation rule includes specification of a user identifier and a type indicator.

13. The method of claim 12, wherein the type indicator indicates whether a key is a user-provided key, a system generated key for an index-to-key key-value pair, or a system generated key for a key-to-index key-value pair.

14. The method of claim 11, wherein the concatenation rule is a prefix rule.

15. A device for providing traversable key-value data storage on a storage system, comprising:
one or more processors; and
one or more computer-readable memories coupled to the one or more processors and having instructions stored thereon that are executable by the one or more processors, wherein the one or more processors are configured to:
receive a first user-provided key-value pair for recordation on a storage system, the first user-provided key-value pair comprising a first user-provided key and a first user-provided value;
assign a first index to the first user-provided key-value pair;
generate a first index-to-key key-value pair, the first index-to-key key-value pair being separate from the first user-provided key-value pair, the first index-to-key key-value pair having a key comprising the first index assigned to the first user-provided key-value pair and a value comprising the first user-provided key in the first user-provided key-value pair;
generate a first key-to-index key-value pair, the first key-to-index key-value pair being separate from the first index-to-key key-value pair and the first user-provided key-value pair, the first key-to-index key-value pair having a key comprising the first user-provided key in the first user-provided key-value pair and a value comprising the first index assigned to the first user-provided key-value pair;
store the first user-provided key-value pair, the first index-to-key key-value pair, and the first key-to-index key-value pair on the storage system; and
facilitate a data operation on the first user-provided key-value pair based on at least one of the first index-to-key key-value pair and the first key-to-index key-value pair stored on the storage system.

16. (canceled)

17. A non-transitory computer-readable medium having stored therein instructions that, when executed by a processor of a device, cause the device to perform a method for providing traversable key-value data storage, the method comprising:
receiving a first user-provided key-value pair for recordation on a storage system, the first user-provided key-value pair comprising a first user-provided key and a first user-provided value;
assigning a first index to the first user-provided key-value pair;
generating a first index-to-key key-value pair, the first index-to-key key-value pair being separate from the first user-provided key-value pair, the first index-to-key key-value pair having a key comprising the first index assigned to the first user-provided key-value pair and a value comprising the first user-provided key in the first user-provided key-value pair;
generating a first key-to-index key-value pair, the first key-to-index key-value pair being separate from the first index-to-key key-value pair and the first user-provided key-value pair, the first key-to-index key-value pair having a key comprising the first user-provided key in the first user-provided key-value pair and a value comprising the first index assigned to the first user-provided key-value pair;
storing the first user-provided key-value pair, the first index-to-key key-value pair, and the first key-to-index key-value pair on the storage system; and
facilitating a data operation on the first user-provided key-value pair based on at least one of the first index-to-key key-value pair and the first key-to-index key-value pair stored on the storage system.

18. The device of claim 15, wherein the one or more processors are further configured to:
provide the traversable key-value data storage on a blockchain; and
provide a programming interface to receive a data request from a smart contract executing on the blockchain.

19. The device of claim 15, wherein the one or more processors are further configured to:
receive a request to traverse through a plurality of user-provided key-value pairs stored on the storage system;
determine a list of indices assigned to the plurality of user-provided key-value pairs;
traverse through a plurality of index-to-key key-value pairs based on the list of indices to obtain a list of user-provided keys; and
traverse through the plurality of user-provided key-value pairs based on the obtained list of user-provided keys.

20. The device of claim 15, wherein the one or more processors are further configured to:
receive a second user-provided key-value pair for recordation on the storage system, the second user-provided key-value pair comprising a second user-provided key and a second user-provided value;
determine whether any user-provided key-value pair stored on the storage system comprises a user-provided key matching the second user-provided key; and
in response to a determination that a particular user-provided key-value pair stored on the storage system comprises a user-provided key matching the second user-provided key, set the second user-provided value as the value for the particular user-provided key-value pair.

21. The device of claim 20, wherein the one or more processors are further configured to:
in response to a determination that no user-provided key-value pair stored on the storage system comprises a user-provided key matching the second user-provided key, process the second user-provided key-value pair for recordation on the storage system.
